(19) United States
(12) Patent Application Publication
(10) Pub. No.: US 2012/0188518 A1
(43) Pub. Date: Jul. 26, 2012

(54) LIGHT SOURCE DEVICE AND PROJECTION DISPLAY APPARATUS

(75) Inventors: Tatsuya MUKOUYAMA, Yokohama-shi (JP); Tatsuru KOBAYASHI, Yokohama-shi (JP)

(73) Assignee: JVC KENWOOD CORPORATION, Yokohama-shi (JP)

(21) Appl. No.: 13/356,048

(22) Filed: Jan. 23, 2012

(30) Foreign Application Priority Data
Jan. 24, 2011 (JP) JP2011-011816
Dec. 26, 2011 (JP) JP2011-283294

(51) Int. Cl. G03B 21/14; F21V 29/00; F21V 9/16

(52) U.S. Cl. 353/31; 362/84

(57) ABSTRACT

A light source device includes a fluorescent assembly and a light tunnel. The light tunnel is located on the fluorescent assembly with no gap.

### CROSS REFERENCE TO RELATED APPLICATION

This application claims benefit of priority under 35 U.S.C. §119 to Japanese Patent Applications No. 2011-11816 filed on Jan. 24, 2011 and No. 2011-283294 filed on Dec. 26, 2011, the entire contents of which are incorporated by reference herein.

### BACKGROUND OF THE INVENTION

1. Field of the Invention

The present invention relates to a light source device and a projection display apparatus using the light source device.

2. Description of the Related Art

FIG. 1 shows one of the conventionally-known light source devices in which LEDs 201 as a light source are mounted on a cavity structure 202, and a light guide 205 such as a light tunnel is provided on an opening (a light-emitting surface) side of the cavity structure 202 via a gap 206. The gap 206 in this case is ensured as a margin necessary for assembly of the cavity structure 202 and the light guide 205.

FIG. 2 also shows one of the conventionally-known light source devices in which a fluorescent body 253, which is formed on a glass substrate 252 rotatably supported by a main body, is irradiated with light flux from a semiconductor laser emitter 251, and a light guide 254 such as a light tunnel is provided in a position adjacent to the area where the fluorescent body 253 glows and away from the glass substrate 252 (for example, refer to Patent Document 1: Japanese Patent Application Laid-open Publication No. 2009-277516). The light source device in this case is also provided with a gap 256 between the fluorescent body 253 on the glass substrate 252 and the light guide 254.

In the conventional light source devices described above, since there is the gap 206 provided between the cavity structure 202 and the light guide 205 or the gap 256 provided between the cavity the fluorescent body 253 and the light guide 254, light leaks from the gap 206 or 256, which reduces efficiency in the use of light.

### SUMMARY OF THE INVENTION

The present invention has been made in view of the conventional problem described above. It is an object of the present invention to provide a light source device capable of improving efficiency in the use of light by preventing leakage of light, and provide a projection display apparatus using the light source device.

In order to solve the above-descried problem, a first aspect of the present invention is a light source device including: a luminescent body; and a light tunnel located on the luminescent body with no gap.

A second aspect of the present invention is the light source device according to the first aspect, wherein the luminescent body includes a fluorescent assembly.

A third aspect of the present invention is the light source device according to the second aspect, further comprising: a laser emitter disposed at an output side of the light tunnel for emitting the excitation light; and a heat sink disposed on the fluorescent assembly for releasing heat.

A fourth aspect of the present invention is the light source device according to the third aspect, wherein the fluorescent assembly is made by a fluorescent layer on a part of a surface of the heat sink.

A fifth aspect of the present invention is the light source device according to the second aspect, wherein the fluorescent assembly includes a fluorescent layer, and the fluorescent layer is segmented into fluorescent bodies of blue color, green color and red color in accordance with a predetermined color ratio.

A sixth aspect of the present invention is a projection display apparatus, including: a light source device including: a luminescent body; and a light tunnel located on the luminescent body with no gap; a display element that modulates light from the light source device; and a projection lens by which an image emitted from the display element is projected on a screen.

### BRIEF DESCRIPTION OF THE DRAWINGS

FIG. 1 is a view showing an example of a conventional light source device.

FIG. 2 is a view showing another example of a conventional light source device.

FIG. 3 is a cross-sectional view of an essential part of a light source device according to a first embodiment of the present invention.

FIG. 4 is an enlarged cross-sectional view of a fluorescent assembly used in the light source device according to the first embodiment of the present invention.

FIG. 5 is a schematic view showing a first configuration example of the light source device according to the first or second embodiment of the present invention.

FIG. 6 is a schematic view showing a second configuration example of the light source device according to the first or second embodiment of the present invention.

FIG. 7A is a cross-sectional view of an essential part of the light source device according to the second embodiment of the present invention.

FIG. 7B is a cross-sectional view of a fluorescent assembly into which a heat sink is integrated, used in the light source device according to the second embodiment of the present invention.

FIG. 8 is a schematic view showing an example of a projection display apparatus including the light source device of the first configuration example in FIG. 5.

FIG. 9A is an explanatory diagram showing an intensity of green light in the light source device according to the first embodiment of the present invention.

FIG. 9B is an explanatory diagram showing an intensity of green light in a light source device.

FIG. 10A is a chromaticity diagram of a white balance of green light in the light source device according to the first embodiment of the present invention.

FIG. 10B is a chromaticity diagram of a white balance of green light in a light source device.

FIG. 11 is a schematic view showing another example of a projection display apparatus including the light source device of the first configuration example in FIG. 5.

FIG. 12A is a configuration diagram of an essential part of the light source device used in the projection display apparatus shown in FIG. 11 in the case where the light source device includes a white fluorescent layer as a fluorescent layer of a fluorescent assembly.

FIG. 12B is a configuration diagram of an essential part of the light source device used in the projection display apparatus shown in FIG. 11 in the case where the light source device includes a three-color fluorescent layer of R, G and B as a fluorescent layer of the fluorescent assembly.

FIG. 13 is a diagram showing spectral characteristics of fluorescent bodies in a three-color fluorescent layer and spectral characteristics of ultraviolet light or near-ultraviolet light from a laser emitter used as an excitation light source in the light source device according to the second embodiment of the present invention.

FIG. 14 is a diagram showing a chromaticity range of a three-color fluorescent layer and a white light-emitting layer used in the light source device according to the second embodiment of the present invention.

### DESCRIPTION OF THE EMBODIMENTS

Hereinafter, a description will be made below of embodiments of the present invention with reference to the drawings.

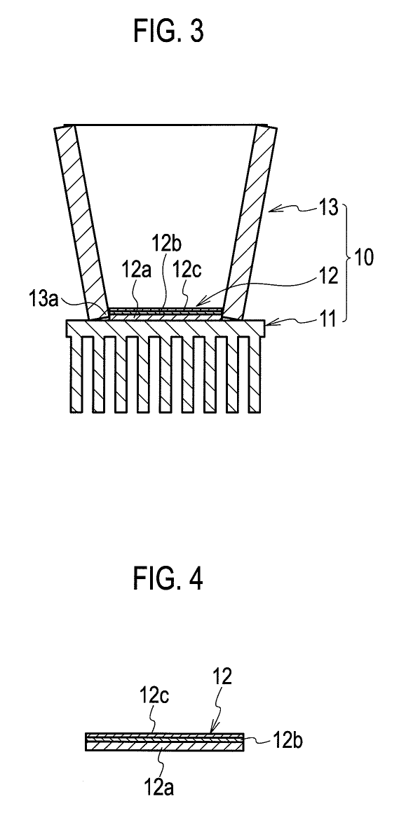

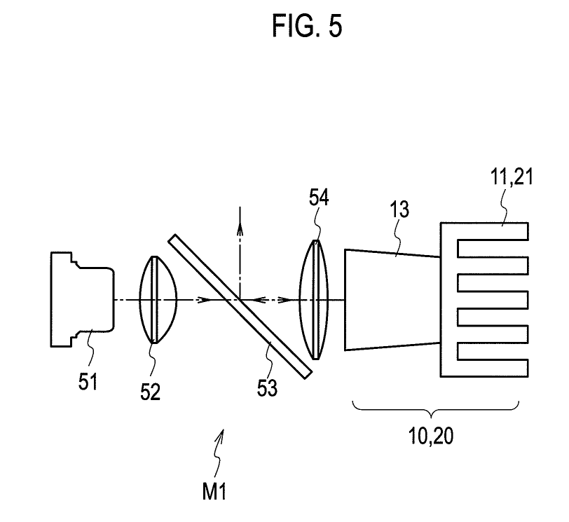

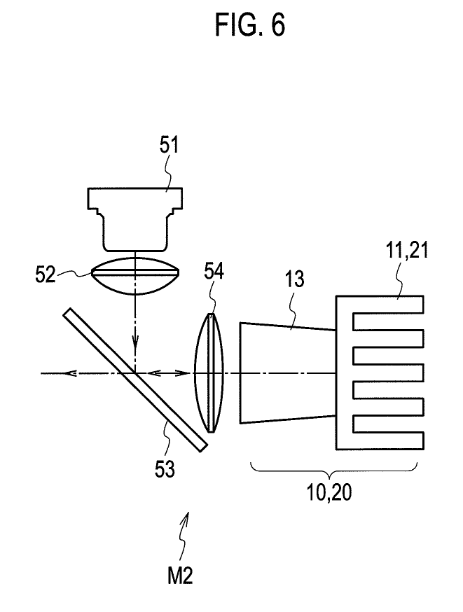

FIG. 3 is a cross-sectional view of an essential part of a light source device according to a first embodiment of the present invention, FIG. 4 is an enlarged cross-sectional view of a fluorescent assembly used in the light source device according to the first embodiment of the present invention, FIG. 5 is a view showing the first configuration example of the light source device according to the first or second embodiment of the present invention, and FIG. 6 is a view showing the second configuration example of the light source device according to the first or second embodiment of the present invention.

As shown in FIGS. 5 and 6, each of light source devices M1 and M2 includes a light source assembly 10 (or 20), a laser emitter 51, and a dichroic mirror 53 and lenses 52 and 54 provided between the light source assembly 10 (or 20) and the laser emitter 51. In the example of FIG. 5, the laser emitter 51 is located on an optical axis of the light source assembly 10. Meanwhile, in the example of FIG. 6, the laser emitter 51 is located on an axis perpendicular to the optical axis of the light source assembly 10.

As shown in FIG. 3, the light source assembly 10 includes a heat sink 11, a fluorescent assembly (luminescent body) 12 and a light tunnel 13. The fluorescent assembly 12 has a fluorescent layer (luminescent surface) 12c that glows by excitation light from the laser emitter 51. The light tunnel 13 is provided to the fluorescent assembly 12 in such a manner that an opening on the incident side thereof is located in one side of the fluorescent assembly 12 (the side of fluorescent layer 12c). The heat sink 11 is provided to the fluorescent assembly 12 in such a manner that an upper surface thereof is located in another side of the fluorescent assembly 12 (the side of substrate 12a) which is an opposite side of the light tunnel 13. The upper surface of the heat sink 11 is closely-attached to the back surface of the fluorescent assembly 12.

The light tunnel 13 includes four rectangular mirrors, each of which includes a glass substrate provided with a reflective mirror layer on one side thereof, and is assembled in such a manner that a mirror surface of each reflective mirror layer faces inward. The light tunnel 13 is formed into a prismatic shape whose an opening increases in width toward an emitting side thereof, to efficiently introduce light from the fluorescent layer 12c to the emitting side. An opening edge 13a of the light tunnel 13 on the incident side is in contact with a peripheral edge of the fluorescent assembly 12 with no gap. The fluorescent assembly 12 includes the substrate 12a made of, for example, metal, high heat-conductive ceramics or glass in which the fluorescent layer 12c is formed on the surface of the substrate 12a, and also includes a metal reflective film 12b formed between the fluorescent layer 12c and the substrate 12a.

In FIG. 5, light emitted from the laser emitter 51 is received by the fluorescent layer 12c of the fluorescent assembly 12 in the light tunnel 13 through the lens 52, the dichroic mirror 53 and the lens 54 in this order. Light generated in the fluorescent layer 12c passes through the light tunnel 13 and is then reflected by the dichroic mirror 53. Accordingly, the light is used as illuminating light for a display apparatus.

In FIG. 6, light emitted from the laser emitter 51 is reflected by the dichroic mirror 53 and enters the light tunnel 13. Then, the light is received by the fluorescent layer 12c of the fluorescent assembly 12 in the light tunnel 13. Light generated in the fluorescent layer 12c passes through the light tunnel 13 and is then transmitted through the dichroic mirror 53. Accordingly, the light is used as illuminating light for a display apparatus.

As described above, the opening edge 13a of the light tunnel 13 on the incident side in the light source assembly 10 is in contact with the peripheral edge of the fluorescent assembly 12, which eliminates a gap between the light tunnel 13 and the fluorescent assembly 12. Accordingly, in the case where the light source device M1 or M2 is used as a light source, light generated in the fluorescent layer 12c can be emitted outward through the light tunnel 13 without leakage of light, which improves efficiency in the use of light.

In particular, the metal reflective film 12b is provided between the substrate 12a and the fluorescent layer 12c. Therefore, light generated in the fluorescent layer 12c excited by laser light can be emitted outward through the light tunnel 13 efficiently while a part of the generated light is reflected by the metal reflecting film 12b. In addition, heat release in the fluorescent assembly 12 can be efficiently carried out using the heat sink 11, which improves reliability of the fluorescent assembly 12.

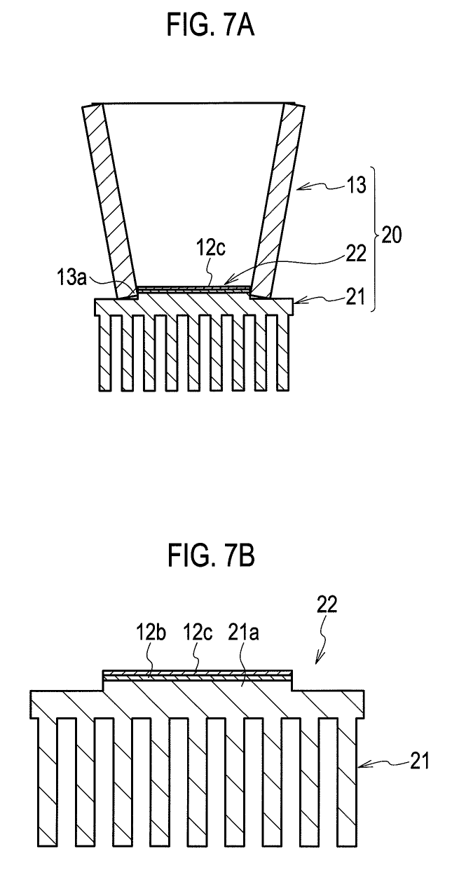

FIG. 7A is a cross-sectional view of an essential part of a light source device according to a second embodiment of the present invention. FIG. 7B is a cross-sectional view of a fluorescent assembly into which a heat sink is integrated, used in the light source device according to the second embodiment of the present invention.

In the first embodiment described above, the heat sink 11 is separated from the fluorescent assembly 12. Meanwhile, a light source assembly 20 according to the second embodiment adopts a fluorescent assembly 22 into which a heat sink 21 is integrated. The fluorescent assembly 22 into which the heat sink 21 is integrated is provided with a convex portion 21a formed with a part of the surface of the heat sink 21, and further provided with the fluorescent layer 12c formed via the metal reflective film 12b on the surface of the convex portion 21a to be used as a substrate. The opening edge 13a of the light tunnel 13 is in contact with the periphery of the convex portion 21a of the fluorescent assembly 22 with no gap. In the case where the heat sink 21 is made of metal such as aluminum, the metal reflective film 12b may be formed with a mirrored surface of the convex portion 21a. The light source assembly 20 according to the second embodiment also composes the light source device in combination with the laser emitter 51 as shown in FIGS. 5 and 6. According to the second embodiment, the fluorescent assembly 22 is integrally-formed with the heat sink 21, the convex portion 21a which is a part of the surface of the heat sink 21 to be used as the substrate, and the fluorescent layer 12c formed via the metal reflective film 12b on the surface of the convex portion 21a, which achieves simplification of assembly, in addition to the technical effect obtained in the first embodiment.

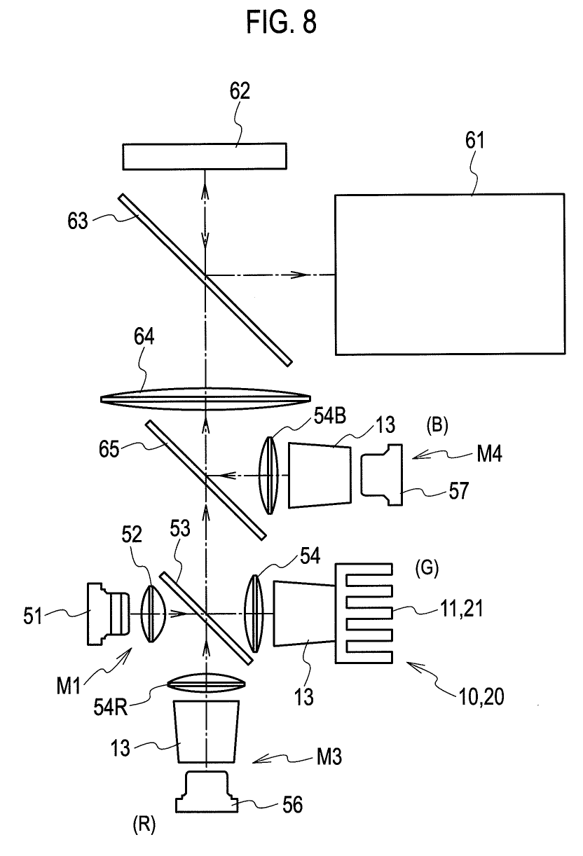

FIG. 8 is a configuration diagram of a projection display apparatus including the light source device M1 shown in FIG. 5 used as a light source of G (green color).

The projection display apparatus includes a light source device M3 of R (red color) and a light source device M4 of B (blue color) in addition to the light source device M1 as the light source of G (green color). The light source device M3 of R (red color) has a configuration in which a red light emitting diode 56, the light tunnel 13 and the lens 54R are combined together. The light source device M4 of B (blue color) has a configuration in which a blue light emitting diode 57, the light tunnel 13 and the lens 54B are combined together. The projection display apparatus thus includes these light source devices M1, M3 and M4, dichroic mirrors 53 and 65, a lens 64, a PBS (polarizing beam splitter) 63, a display element 62, and a projection lens 61 shown as a unit. Although The PBS 63 is a wire grid PBS, it may be a PBS including a polarizing beam splitter film provided between glass blocks. Light emitted from the respective light source devices M1, M3 and M4 is introduced into the display element 62 through the lenses 52, 54, 54R, 54B and 64, the dichroic mirrors 53 and 65, and the PBS 63. Then, an image output from the display element 62 is projected on a screen through the projection lens 61 and the PBS 63. The display element 62 used herein may be a reflective liquid crystal element or a reflective display element such as a digital micromirror device (DMD), or may be a transmissive liquid crystal element.

In the project display unit, light emitted from the laser emitter 51 with short-wavelength ray of approximately 400 nm or less is transmitted through the dichroic mirror 53, and the light is received by the fluorescent layer 12c in the light tunnel 13. Green light generated in the fluorescent layer 12c passes through the light tunnel 13 and is reflected by the dichroic mirror 53. Then, the green light is transmitted through the dichroic mirror 65 and the PBS 63, and illuminates the display element 62. Light from the red light emitting diode 56 passes through the light tunnel 13, is transmitted through the dichroic mirror 53, the dichotic mirror 65 and the PBS 63, and illuminates the display element 62. Light from the blue light emitting diode 57 passes through the light tunnel 13, is reflected by the dichroic mirror 65 and transmitted through the PBS 63, and illuminates the display element 62. The display element 62 displays the respective R, G and B images using signals synchronized with R, G and B so that desired images are projected on a screen or the like through the projection lens 61.

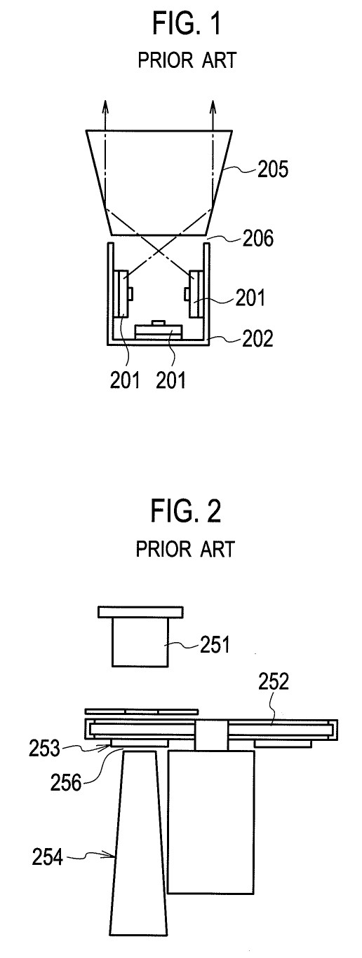

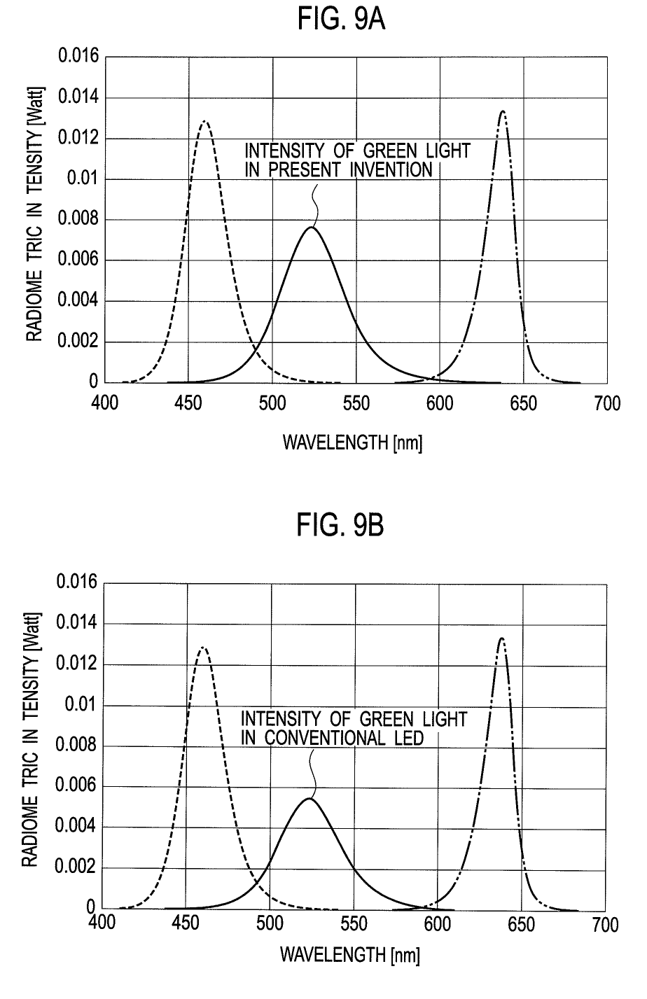

FIGS. 9A and 9B are comparative explanatory diagrams showing an intensity of green light in the case of using the light source device M1 as the light source of G (green color) according to the first embodiment and in the case of using the LED as the conventional light source shown in FIG. 1, respectively.

In the conventional light source device shown in FIG. 1, since there is the gap 206 provided between the cavity structure 202 and the light guide 205 such as a light tunnel, light leaks from the gap 206, which reduces efficiency in the use of light. In addition, as shown in FIG. 9B, the light output in the light wavelength region of green color has a lower peak than that of blue color or red color, and also has a small area. On the other hand, the light source device M1 according to the first embodiment uses green light generated in the fluorescent layer 12c excited by semiconductor laser (ultraviolet light) from the laser emitter 51 instead of the green LED. Therefore, the intensity of green light can be relatively increased. As shown in FIG. 9A, it is recognized that the peak and area of the light output in the light wavelength region of green color increase compared with the conventional light source device shown in FIG. 9B. Since the laser light source such as semiconductor laser has small etendue, light can be collected on the fluorescent layer 12c with high efficiency to excite the fluorescent layer 12c even when several lasers are coupled.

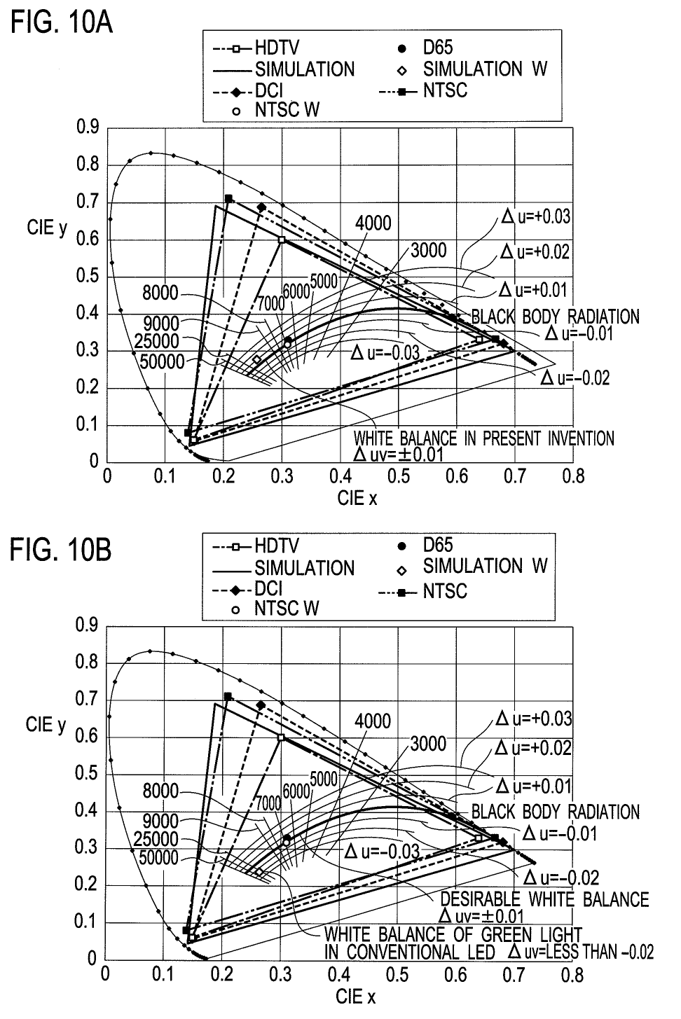

FIGS. 10A and 10B are comparative chromaticity diagrams of a white balance of green light in the case of using the light source device M1 as the light source of G (green color) according to the first embodiment and in the case of using the LED as the conventional light source shown in FIG. 1, respectively.

As shown in FIG. 10B, in the case of using the LED as the conventional light source, the point indicated by the white diamond shape in the chromaticity diagram is a value of white color obtained through a simulation, and a deviation from black body radiation is approximately −0.025, which is out of ±0.01 of an allowable deviation range from the blackbody radiation. Namely, since the light output of the three primary colors of RGB is out of balance, a desired light output in white color is not obtained. On the other hand, according to the result of the simulation in the first embodiment shown in FIG. 10A, the point indicated by the white diamond shape is a value of white color, and a deviation from the black body radiation is within ±0.01, which means that white color is well-balanced. Thus, the green fluorescent layer 12c is excited by excitation light of semiconductor laser (ultraviolet light) and the green light generated in the fluorescent layer 12c is fully used as illuminating light in the light tunnel 13 that has no gap, which exerts the maximum effect. Note that, HDTV in FIGS. 10A and 10B is an abbreviation for a high-definition television (a high-quality television) of which resolution is more than twice as high as a standard-definition television (SDTV). D65 is a light source (one of the standardized light sources) standardized by public institutions such as CIE (International Commission on Illumination) and ISO (International Organization for Standardization), and is a light source for measurement of an object color irradiated with daylight, which is commonly used for a projector or the like. DCI represents a DCI standard that standardizes digital cinemas (showed by recent high-definition projectors). NTSC is an abbreviation for National Television System Committee.

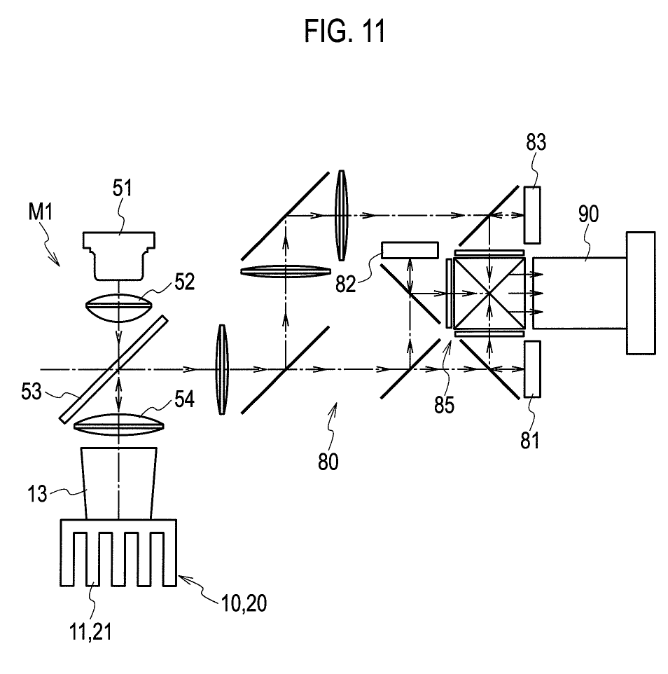

FIG. 11 is a configuration diagram of a projection display apparatus using the light source device M1 shown in FIG. 5 as a white light source.

In the projection display apparatus, light emitted from the laser emitter 51 is transmitted through the dichroic mirror 53 and enters the light tunnel 13. Then, white light generated in the fluorescent layer 12c is reflected by the dichroic mirror 53, passes through a resolution optical system 80, and illuminates the respective display elements 81, 82 and 83. The images produced in the respective display elements 81, 82 and 83 are synthesized via a synthesizing optical system 85 so that desired images are projected on a screen or the like by a projection lens 90.

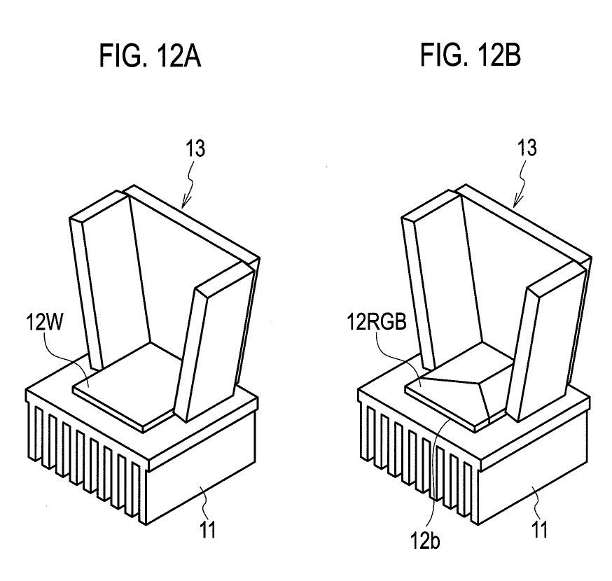

The light source device M1 used as the white light source includes an entirely-uniform white fluorescent layer 12W used as the fluorescent assembly 12 as shown in FIG. 12A, or a fluorescent layer 12RGB segmented into three colors of R (red color), G (green color) and B (blue color) as shown in FIG. 12B.

That is, the fluorescent layer 12RGB shown in FIG. 12B is segmented into three regions. The respective regions are coated with a blue luminescent body, a green luminescent body and a red luminescent body excited by ultraviolet light or near-ultraviolet light to generate blue light, green light and red light, respectively.

Thus, the projection display apparatus using the light source device M1 shown in FIG. 11 as the white light source is provided with the laser emitter 51 that emits ultraviolet light or near-ultraviolet light, and provided with the lens 52 and the lens 54 to collect the ultraviolet light or near-ultraviolet light emitted from the laser emitter 51 in the light tunnel 13 with high efficiency. As shown in FIG. 12B, the end surface opposed to the opening of the light tunnel 13 on the incident side is provided with the metal reflective film 12b to form a mirror surface on the heat sink 11. The fluorescent layer 12RGB is formed in such a manner that the metal reflective film 12b is coated with the fluorescent bodies to be excited by ultraviolet light or near-ultraviolet light to generate blue light, green light and red light, respectively. The ultraviolet light or near-ultraviolet light emitted from the laser emitter 51 passes through the light tunnel 13 toward the respective fluorescent bodies on the fluorescent layer 12RGB while repeating multiple reflections in the light tunnel 13, and illuminates the fluorescent bodies on the fluorescent layer 12RGB at the end surface of the light tunnel 13 with high efficiency. The generated blue light, green light and red light excited by the ultraviolet light or near-ultraviolet light from the laser emitter 51 travel backward to enter the lens 54 to be parallel light while repeating multiple reflections in the light tunnel 13 again. Then, the blue light, green light and red light are reflected by the dichroic mirror 53 that reflects longer wave than blue light and transmits the ultraviolet light or near-ultraviolet light from the laser emitter 51.

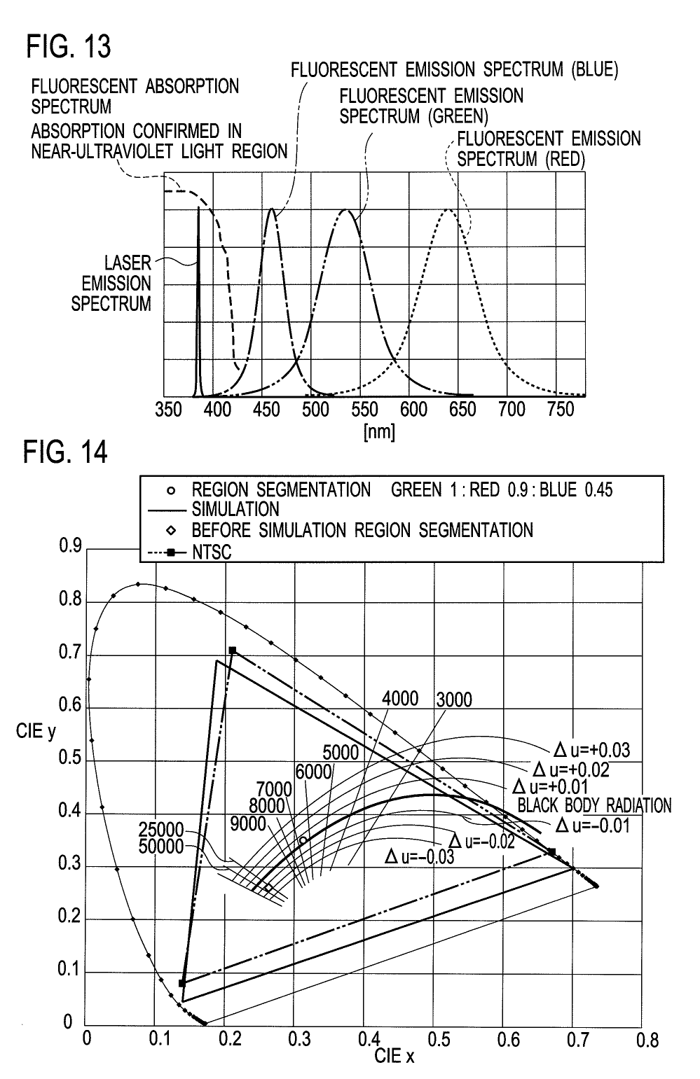

FIG. 13 shows spectral characteristics of the fluorescent bodies in the three-color fluorescent layer 12RGB and spectral characteristics of ultraviolet light or near-ultraviolet light from the laser emitter 51 as an excitation light source used in the light source device M1 according to the second embodiment of the present invention. FIG. 14 shows chromaticity ranges of the three-color fluorescent layer 12RGB and the white fluorescent layer 12W used in the light source device M1 according to the second embodiment of the present invention.

In the case in which the RGB fluorescent bodies in RGB fluorescent segmentation are mixed and segmented, a chromaticity point of white light emission by excitation light of ultraviolet light or near-ultraviolet light from the laser emitter 51 is W(x, y):(0.2631, 0.2379), and a color temperature is 3000 K and a deviation is −0.0158. Thus, the color results in bluish and slightly purple white. As a measure against this matter, the fluorescent bodies are segmented to optimize the white balance. For example, in the case of adjusting the white balance to D65, the fluorescent ratio of green, red and blue is set to 1:0.9:0.45. Accordingly, the color temperature of 6500 K and the deviation of 0.0032 are realized.

In this case, if the fluorescent bodies of green, red and blue are mixed and dispersed, it is difficult to distinguish the fluorescent bodies by appearance because fluorescence from the fluorescent bodies is adsorbed to fluorescent bodies of other color components, or dependency on qualitative know-how such as a production method to efficiently disperse plural fluorescent bodies is increased.

Thus, as in the case of the three-color fluorescent layer 12RGB shown in FIG. 12B, the fluorescent layer is segmented into the respective fluorescent bodies of blue, green and red, and the white balance is controlled by the segmentation ratio thereof. Accordingly, the fluorescent bodies can be controlled quantitatively.

A first aspect of one embodiment is a light source device including: a luminescent body; and a light tunnel whose an opening on an incident side is located on a luminescent surface of the luminescent body, wherein the light tunnel has an opening edge at the incident side thereof that is in contact with a peripheral edge of the luminescent surface of the luminescent body.

According to the first aspect of one embodiment, the opening edge on the incident side of the light tunnel is in contact with the peripheral edge of the luminescent surface of the luminescent body. Therefore, a gap between the light tunnel and the luminescent body can be eliminated. Accordingly, efficiency in the use of light can be improved since light from the luminescent body can be emitted outward through the light tunnel without leakage of light.

A second aspect of one embodiment is the light source device according to the first aspect, wherein the luminescent body includes a fluorescent assembly in which a fluorescent layer that generates light by excitation light from outside is formed on a surface of a substrate, the opening on the incident side of the light tunnel is located on a side of the fluorescent layer of the fluorescent assembly, and the opening edge at the incident side is in contact with a peripheral edge of the fluorescent assembly.

According to the second aspect of one embodiment, light from the fluorescent layer excited by excitation light can be emitted outward through the light tunnel without leakage of light.

A third aspect of one embodiment is the light source device according to the second aspect, wherein the fluorescent layer is formed on the surface of the substrate via a reflective film, a laser emitter is disposed at an output side of the light tunnel and emits the excitation light, and a heat sink for heat release is disposed on a back side of the fluorescent assembly.

According to the third aspect of one embodiment, the fluorescent layer is formed on the surface of the substrate via the reflective film, the laser emitter is disposed at the output side of the light tunnel and emits the excitation light, and the heat sink for heat release is disposed on the back side of the fluorescent assembly. Therefore, light from the fluorescent layer excited by laser light can be emitted outward through the light tunnel efficiently while a part of the light is reflected by the reflective film. In addition, heat release in the fluorescent assembly can be efficiently carried out using the heat sink. Accordingly, reliability of the fluorescent assembly can be improved.

A fourth aspect of one embodiment is the light source device according to the third aspect, wherein the fluorescent assembly is made by forming the fluorescent layer on a part of a surface of the heat sink used as the substrate via the reflective film.

According to the fourth aspect of one embodiment, assembly simplification can be achieved since the fluorescent assembly uses a part of the surface of the heat sink as the substrate.

A fifth aspect of one embodiment is the light source device according to the second aspect, wherein the fluorescent layer is segmented into fluorescent bodies of blue color, green color and red color in accordance with a predetermined color ratio.

According to the fifth aspect of one embodiment, the fluorescent bodies are excited with high efficiency by excitation light via the light tunnel, and white light in which a balance among blue, green and red is optimized with high efficiency can be obtained.

A sixth aspect of one embodiment is a projection display apparatus, including: a light source device including: a luminescent body; and a light tunnel whose an opening on an incident side is located on a luminescent surface of the luminescent body, wherein the light tunnel has an opening edge at the incident side thereof that is in contact with a peripheral edge of the luminescent surface of the luminescent body; a display element that modulates light from the light source device; and a projection lens by which an image emitted from the display element is projected on a screen.

According to the sixth aspect of one embodiment, the projection display apparatus includes the light source device according to the first aspect. Accordingly, the above-described effects can be achieved.

What is claimed is:

1. A light source device comprising:
a luminescent body; and
a light tunnel located on the luminescent body with no gap.

2. The light source device according to claim 1,
wherein the luminescent body includes a fluorescent assembly.

3. The light source device according to claim 2, further comprising:
a laser emitter disposed at an output side of the light tunnel for emitting the excitation light; and
a heat sink disposed on the fluorescent assembly for releasing heat.

4. The light source device according to claim 3,
wherein the fluorescent assembly is made by a fluorescent layer on a part of a surface of the heat sink.

5. The light source device according to claim 2,
wherein the fluorescent assembly includes a fluorescent layer, and the fluorescent layer is segmented into fluorescent bodies of blue color, green color and red color in accordance with a predetermined color ratio.

6. A projection display apparatus comprising:
a light source device comprising:
a luminescent body; and
a light tunnel located on the luminescent body with no gap;
a display element that modulates light from the light source device; and
a projection lens by which image light emitted from the display element is projected on a screen.
